(19) United States
(12) Patent Application Publication
(10) Pub. No.: US 2005/0191917 A1
(43) Pub. Date: Sep. 1, 2005

(54) Composite fabric having a polymeric backing laminate

(76) Inventor: Chun-Wei Lin, Taichung Hsien (TW)

Correspondence Address: LADAS & PARRY LLP, 224 SOUTH MICHIGAN AVENUE, SUITE 1600, CHICAGO, IL, 60604, US

(21) Appl. No.: 10/789,056

(22) Filed: Feb. 27, 2004

(51) Int. Cl. B32B 27/04

(52) U.S. Cl. 442/59; 442/149

(57) ABSTRACT

A composite fabric includes a fabric layer and a backing laminate which is composed of a binder layer applied to the fabric layer, an intermediate layer applied to the binder layer, and a surface-modifying layer applied to the intermediate layer. The binder layer includes a binder composition which contains a styrene-butadiene-styrene block copolymer grafted with an acrylate monomer, and polyurethane blended with the styrene-butadiene-styrene block copolymer which has been grafted. The intermediate layer has a composition, which contains styrene-butadiene-styrene block copolymer. A method of producing the composite fabric is also disclosed.

### BACKGROUND OF THE INVENTION

1. Field of the Invention

This invention relates to laminates, more particularly to a composite fabric comprising a fabric layer having a backing laminate containing styrene-butadiene-styrene block copolymer and polyurethane.

2. Description of the Related Art

It is known in the art to provide a composite fabric which includes one or more polymeric layers on a base fabric. Such composite fabrics are useful for making luggage, bags, tents, curtains, garments, or the like. Composite fabrics incorporating PVC layers are fabricated by laminating a base layer of textile material with a PVC film through a process. Such composite fabrics are inexpensive and exhibit good physical and mechanical properties. The PVC film layer is not only waterproof but also reinforces and stabilizes the texture of the base textile material while providing a good hand feel property. However, PVC, throughout its lifecycle, is the most environmentally damaging material among all plastics because of the stabilizer and plasticizer of PVC, which liberate dioxin along with heavy metal. On the other hand, in backing a fabric with PVC by a calendering process, since the minimum quantities of the fabric and PVC to be processed are limited by the apparatus used in the calendering process, small production is impossible. This can result in surplus inventory and an increase in cost.

Composite fabrics containing polyurethane (PU) are made by applying directly a PU coating to a base textile layer. Due to the direct application of the PU coating, the amount of waste is reduced. When a one-component type polyurethane is used, the waste may be recycled. Basically, PU coatings do not possess the function of adjusting the hand feel property due to the small amount of material contained in the PU coatings, or due to the discontinuity of the films of the PU coatings.

Styrenic block copolymers have been suggested in the art as a substitute for PVC in forming a composite because the stytrenic block copolymer is more environmentally friendly than PVC. Like PVC, styrenic block copolymers can reinforce and stabilize the structure of the fabric. However, although styrenic block copolymers exhibit good hand feel property, since the styrenic block copolymers are typically laminated through a process and since the film forming property of the styrenic block copolymers in its melted state is not as good as PVC, the styrenic block copolymer layer is generally thick and the thickness thereof is hard to be lowered to below 0.15 mm. Furthermore, in processing, the thinner of the film, the more loss of styrenic block copolymer. In addition, the process can produce wastes which are not easily recyclable. Moreover, due to the readily aging property of styrenic block copolymers, the amount of wastes that can be recycled is decreased, thereby increasing the cost of production.

U.S. Pat. No. Re.28,682 discloses a laminate having a textile backing, a crushed, thermoset plastic foam bonded thereto, and a transparent polymeric film overlying the foam, which is preferably thermoset. This patent further discloses that the transparent polymeric film may be prepared from a suitable latex, such as carboxylated SBR containing antioxidants or UV stabilizers, and that examples of other crosslinkable lattices are crude rubber in which 3 percent of the polymer is in the form of combined maleic anhydrice, butadiene styrene copolymers and butadiene-acrylonitrile polymers containing 3 percent to 5 percent carboxylated groups.

### SUMMARY OF THE INVENTION

An object of the invention is to provide a composite fabric with a backing laminate which can be produced easily through a coating process while still providing a thickness sufficient to impart a good hand feel property to the composite fabric.

Another object of the present invention is to provide a composite fabric with a backing laminate which is produced through a coating process and which provides a thickness greater than that of the conventional PU coated fabric.

Still another object of the present invention is to provide a composite fabric which is environmentally safe and easy to recycle.

According to one aspect of the present invention, a composite fabric comprises a fabric layer, and a backing laminate, the backing laminate including a binder layer applied to the fabric layer, an intermediate layer applied to the binder layer, and a surface-modifying layer applied to the intermediate layer, the binder layer having a binder composition which contains a styrene-butadiene-styrene block copolymer grafted with an acrylate monomer, and polyurethane blended with the styrene-butadiene-styrene block copolymer which has been grafted, the intermediate layer having a composition which contains a styrene-butadiene-styrene block copolymer and a solvent.

According to another aspect of the present invention, a method for fabricating a composite fabric comprises the steps of: providing a fabric layer with a binder layer which is prepared by grafting a styrene-butadiene-styrene block copolymer with an acrylate monomer and by blending polyurethane with the styrene-butadiene-styrene block copolymer which has been grafted; applying an intermediate layer to the binder layer, the intermediate layer being formed from a composition which contains a styrene-butadiene-styrene block copolymer and a solvent; and applying a surface-modifying layer to the intermediate layer.

The composition used for forming the binder layer is prepared from polyurethane and styrene-butadiene-styrene (SBS) block copolymer which is grafted with an acrylate monomer. Polyurethane is added to the SBS block copolymer for the purpose of increasing adhesion to the fabric layer and improving the tensile strength of the backing laminate. The use of polyurethane in the surface-modifying layer can enhance scratch resistance and dryness. The primary purpose of the intermediate layer is to provide thickness to the backing laminate due to its lower cost compared to the binder layer and the surface-modifying layer. The SBS block copolymer is grafted with an acrylate monomer in order to improve compatibility of the SBS copolymer to polyurethane.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows a composite fabric embodying the present invention;

FIG. 2 is a schematic view of an apparatus usable in fabricating the composite fabric of the present invention;

FIG. 3 is a schematic view of another apparatus usable in fabricating the composite fabric of the present invention;

FIG. 4 is a schematic view of still another apparatus usable in making the composite fabric of the present invention; and

FIG. 5 illustrates a fabrication process embodying the present invention.

### DETAILED DESCRIPTION OF THE PREFERRED EMBODIMENTS

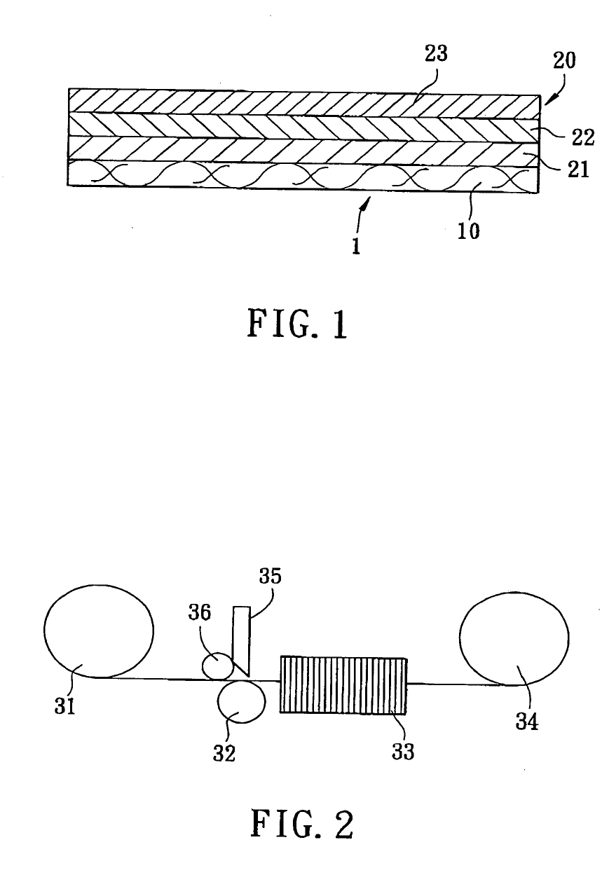

As shown in FIG. 1, a composite fabric 1 embodying the present invention includes a fabric layer 10, and a backing laminate 20 which is composed of a binder layer 21, an intermediate layer 22, and a surface-modifying layer 23. The composite fabric 1 may be used for making luggage, bags, tents, curtains, garments or other suitable products The fabric layer 10 may be of any textile material having suitable woven texture and color to match the desired function and appearance of a final product.

When the composite fabric 1 is formed into a product, the fabric layer 10 may be exposed at the outer side of the product to serve as a face layer, and the backing laminate 20 may be disposed at the inside of the product to reinforce and stabilize the texture of the fabric layer 10, to regulate the hand feel property of the composite fabric 1 and to provide a waterproofing effect. Alternatively, the backing laminate 20 may be disposed at the outer side of the product to serve as a face layer and may be provided with different colors and/or embossed patterns to match the design of the final product.

The binder layer 21 primarily functions to provide a good bonding between the fabric layer 10 and the intermediate layer 22 and is formed from a binder composition which includes a styrene-butadiene-styrene block copolymer grafted with an acrylate monomer and blended with polyurethane. The styrene-butadiene-styrene block copolymer is grafted with an acrylic monomer before being blended with polyurethane so as to improve the compatibility of the styrene-butadiene-styrene block copolymer and polyurethane.

Examples of acrylate monomers suitable for grafting the styrene-butadiene-styrene block copolymer include 2-ethyl hexyl acrylate (2-EHA), 2-hydroxy ethyl acrylate (2-HEA), acrylic acid (AA), butyl acrylate (BA), ethyl acrylate (EA), methyl acrylate (MA), 2-ethyl hexyl methacrylate (2-EHMA), 2-hydroxy ethyl methacrylate (2-HEMA), 2-hydroxy propyl methacrylate (2-HPMA), dimethyl amino ethyl methacrylate (DMAEMA), ethyl methacrylate (EMA), glycidyl methacrylate (GMA), isobutyl methacrylate(IBMA), lauryl methacrylate (LMA), methacrylate acid (MAA), methyl methacrylate (MMA), n-butyl methacrylate (NBMA), stearyl methacrylate (SMA), a combination of two or more of the aforesaid monomers and other suitable acrylate monomers.

Examples of solvents suitable for dissolving styrene-butadiene-styrene block copolymers are toluene, n-butyl acetate and cyclohexane. The reaction product of a styrene-butadiene-styrene block copolymer and an acrylate monomer in the present invention may have a viscosity ranging from 8,000 CPS to 10,000 CPS. The viscosity may be adjusted according to the specification of the fabric layer. By adding the styrene-butadiene-styrene block copolymer directly to a reaction mixture during the graft polymerization of the styrene-butadiene-styrene block copolymer and the acrylate monomer, the solid content and viscosity can be increased. According to the specification of the conventionally used composite fabric, the viscosity is generally adjusted up to 15,000 cps-30,000 cps.

Polyurethane is added to and blended with the reaction product of the graft polymerization together with a suitable solvent, such as methyl ethyl ketone (MEK). Due to the acrylate monomer grafting the styrene-butadiene-styrene block copolymer, polyurethane can be blended with the grafted styrene-butadiene-styrene block copolymer to form an almost homogeneous phase.

The intermediate layer 22 functions to impart a thickness to the composite fabric 1 and is formed from a composition containing a styrene-butadiene-styrene block copolymer. The composition may be prepared by introducing a solvent and a plasticizer into a mixer where they are heated to a temperature of about 80° C., and then adding thereto a styrene-butadiene-styrene block copolymer to form a styrene-butadiene-styrene block copolymer solution.

The type of styrene-butadiene-styrene block copolymer for the intermediate layer 22 is selected based on the desired physical properties of the composite fabric 1, such as tensile strength, hardness, elasticity or rebound characteristics, etc. The tensile strength is determined by the molecular weight of the styrene-butadiene-styrene block copolymer and the amount of a plasticizer added to the sytrenic block copolymer. The hardness is determined by the ratio of styrene to butadiene contained in the styrene-butadiene-styrene block copolymer and the amount of the plasticizer, whereas the rebound characteristics depend upon the ratio of styrene and butadiene contained in the styrene-butadiene-styrene block copolymer. The tensile strength of the intermediate layer 22 will affect the tearing strength and the stitching strength of the composite fabric 1. The hardness and the rebound characteristics will determine the hand feel property of the composite fabric 1.

The plasticizers usable for the styrene-butadiene-styrene block copolymer may be a paraffinic oil, a napthehenic oil or any other suitable plasticizer. The amount of the plasticizer added to the styrene-butadiene-styrene block copolymer may be adjusted based on the hardness required by the final product. It should be noted that the amount of the plasticizer must be controlled to be below a level which would be so excessive that it can result in a migration problem.

Generally, the cost for producing the composite fabric 1 would be low if the solid content of the intermediate layer 22 is high because the amount of the solvent to be vaporized by an oven is low. However, it is necessary to consider other processing parameters of the intermediate layer 22, such an the speed, the flatness of the backing laminate 20 and the rate of evaporation of the solvent. The viscosity of the composition of the intermediate layer 22 is generally controlled according to the specification of the fabric layer 10, and is preferably kept to be 18,000 cps-20,000 cps.

The styrene-butadiene-styrene block copolymer for the intermediate layer 22 may be foamed or unfoamed. If the styrene-butadiene-styrene block copolymer is foamed by using a blowing agent, the intermediate layer 22 will have increased thickness and softness and will provide a feel of bulkiness and softness. Since the softening point and the heat resistance of the styrene-butadiene-styrene block copolymer are low, the blowing agent for foaming the styrene-butadiene-styrene block copolymer must below. The temperature at which the blowing agent releases a blowing gas is preferably 120° C.-130° C. The amount of the blowing agent is determined by the density desired for the foam resulting from the styrene-butadiene-styrene block copolymer. A preferable amount of the blowing agent is 3 phr-5 phr.

The styrene-butadiene-styrene block copolymer may be foamed in an oven which has a two-stage temperature control system. At the first stage, the temperature must be raised to a level sufficient to vaporize the solvent before the decomposition of the blowing agent. At the second stage, the intermediate layer 22 must be kept at a decomposition temperature for a certain period. In order to avoid the blowing agent from being dispersed unevenly, the blowing agent may be mixed with a solvent before addition to the styrene-butadiene-styrene block copolymer.

The function of the surface-modifying layer 23 is to provide a good feel of touch for the backing laminate 20 and to enhance the scratch-resistance and the coloring ability of the backing laminate 20. The surface-modifying layer 23 is formed from a composition which includes a styrene-butadiene-styrene block copolymer grafted with an acrylate monomer and polyurethane blended with the grafted styrene-butadiene-styrene block copolymer, a lubricant and a matting agent. A mixture of methyl ethyl acetone and toluene may be used to dissolve the styrene.

The lubricant is used for the purpose of increasing the smoothness and the scratch-resistance of the surface of the surface-modifying layer 23. Examples of the lubricant include silicon-based, polyethylene-based, or Teflon-based material. The matting agent is used to eliminate gloss and to provide dryness. The matting agent may be a modified silicon dioxide or nanoparticle calcium carbonate.

In preparing the composition of the surface-modifying layer 23, the lubricant is first mixed with a solvent to form a paste and thereafter, the grafted styrene-butadiene-styrene block copolymer, polyurethane and the matting agent are added to the paste. The viscosity of the resulting mixture is adjusted by adding the solvent. The viscosity is preferably 4,000 cps-8,000 cps. Polyurethane used for the surface-modifying layer 23 is selected from those having high solid content and low viscosity. Molecular weight and scratch-resistance are also parameters to be taken into consideration in selecting suitable polyurethane.

### Examples of the Compositions Used in Forming the Composite Fabric

A binder composition for the binder layer 21 was prepared by reacting 15 parts by weight of styrene-butadiene-styrene block copolymer with 15 parts by weight of methyl acrylate in the presence of 69.4 parts by weight of a solvent, 0.2 parts by weight of benzoyl peroxide (catalyst), and 0.2 part by weight of an antioxidant. A graft polymerization reaction was carried out at a temperature of about 85° C. for 3.5 to 4 hrs. The reaction product has a solid content of 28% and a viscosity of 8,000-10,000 cps. After the reaction is completed, 20 parts by weight of polyurethane was added to the reaction product together with a suitable amount of solvent (methyl ethyl ketone). After mixing, the binder composition was obtained.

In preparing the composition of the intermediate layer 22, 0-50 parts by weight of a plasticizer (paraffinic oil or naphthenic oil) and 100-150 parts by weight of a solvent (toluene, n-butyl acetate or cyclohexane) were first introduced into a mixer. Then, 100 parts by weight of styrene-butadiene-styrene block copolymer was added to and mixed with the contents in the mixer at a temperature of 80° C. After mixing for an hour, the styrene-butadiene-styrene block copolymer was completely dissolved to form a solution.

In preparing the composition of the surface-modifying layer 23, 10 parts by weight of styrene-butadiene-styrene block copolymer was graft polymerized with 20 parts by weight of methyl acrylate in the presence of a solvent mixture (methyl ethyl ketone and toluene in a ratio of 3:1). 2 parts by weight of the lubricant was then added to the solvent mixture to form a paste. To the paste were added 50 parts by weight of the grafted copolymer obtained from the graft polymerization, 100 parts by weight of polyurethane, and 4 parts by weight of a matting agent (modified silicon dioxide or nano calcium carbonate) The viscosity of the resulting composition was adjusted to be 4,000 cps-8,000 cps by controlling the added amount of the solvent. Apparatuses for fabricating the composite fabric

The composite fabric 1 may be fabricated through knife coating and gravure coating processes. There are two types of knife coating processes, namely, gap coating and suspension coating. In manufacturing the composite fabric 1, gravure, gap and suspension coating processes may be used alone, or in combination, depending on the desired quality of the product. For example, if the product demands a resistance to hydraulic pressure and does not require hand feel properties, the suspension coating process alone may be performed without using the gap coating process. As such, the desired quality may be achieved without a waste of production cost. The different apparatuses usable for the fabrication of the composite fabric 1 are shown in FIGS. 2-4.

As shown in FIG. 2, an apparatus for gap coating is shown to include a fabric roll 31, a support roller 32, an oven 33, a take-up roller 34, and a coating knife 35. Numeral 36 represents a coating material.

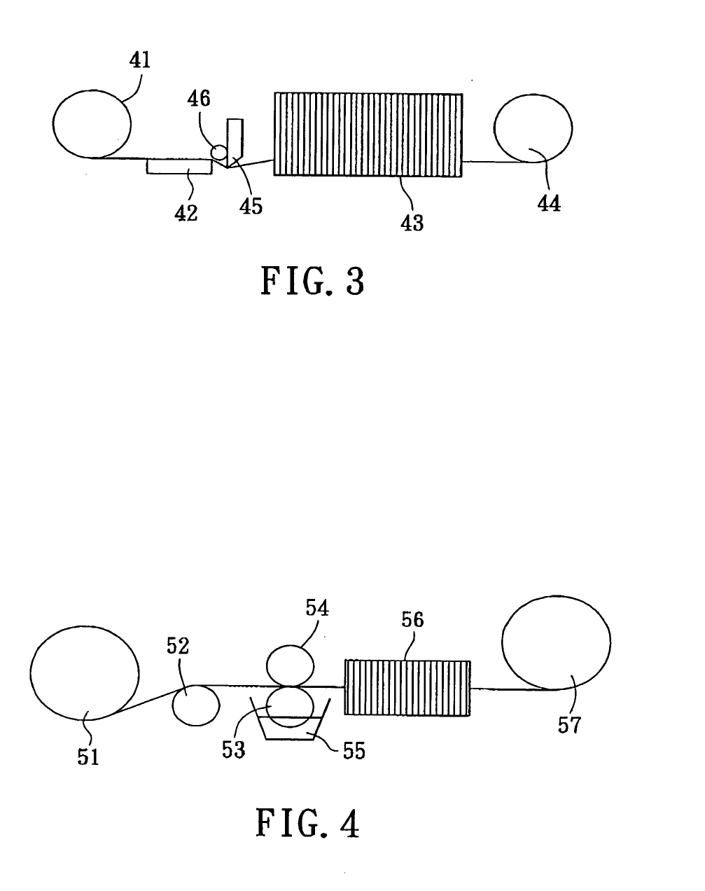

As shown in FIG. 3, an apparatus for suspension coating is shown to include a fabric roll 41, a flat plate support 42, an oven 43, a take-up roller 44, a coating knife 45. Numeral 46 denotes a coating material.

As shown in FIG. 4, an apparatus for gravure coating is shown to include a fabric roll 51, a guide roller 52, a coating roller 53 with an engraved pattern, a rubber roller 54, a surface treatment agent 55, an oven 56, and a take-up roller 57.

In suspension coating, the amount of a coating material consumed is determined by the thickness, shape and angle of the coating knife 35 and the tension of the fabric sheet fed from the fabric roll 41. Since the coating solution is coated through a forced feeding manner, the coating solution can easily penetrate into the structure of the fabric, and effective reinforcement and stabilization of the fabric can therefore be achieved. The suspension coating is suitable for coating the binder layer 21 of the composite fabric 1.

Gap coating is suitable for forming the intermediate layer 22 of the composite fabric 1. The thickness of the intermediate layer 22 may be controlled by adjusting the distance between the coating knife 45 and the surface of the fabric fed from the fabric roll 41.

Gravure coating can prevent formation of scratches on the surface of a coating during the coating process and therefore may be used for decoration and ornamentation purposes. The amount of the coating material consumed depends upon the engraved pattern of the coating roller 53.

Fabrication of the Composite Fabric

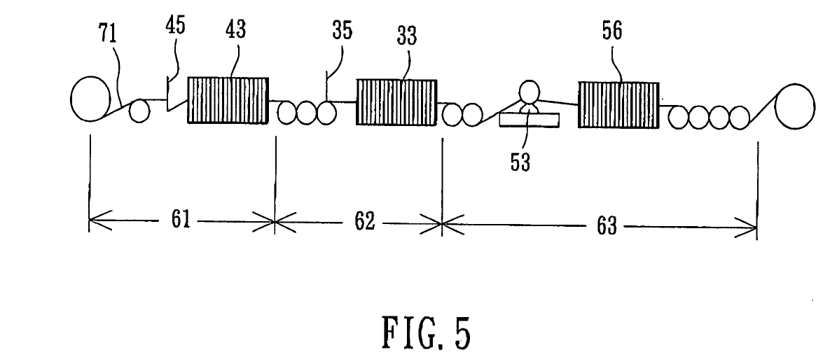

Referring to FIG. 5, a preferred embodiment of the present invention for fabricating the composite fabric 1 is shown. An overall apparatus for the fabrication process is provided by combining the apparatuses shown in FIGS. 2 to 4, and includes three sections, namely, a suspension coating section 61, a gap coating section 62 and a gravure coating section 63. In the suspension coating section 61, a coating having the binder composition according to the present invention is applied to a fabric 71 through a suspension coating process using a coating knife 45 to provide the binder layer 21. In the gap coating section 62, a coating containing the composition of the intermediate layer 22 according to the present invention is applied to the binder layer 21 through the gap coating process using a coating knife 35. In the gravure coating section, a coating having the composition of the surface-modifying layer 23 according to the present invention is applied to the intermediate layer 22 through the gravure coating process using a coating roller 53.

The amount of the binder composition of the binder layer 21 varies depending on the type and specification of the fabric used in the process. The more the number of deniers in the fabric layer 10, the higher will be the amount of the coating composition consumed.

The intermediate layer 22 primarily determines the thickness of the composite fabric 1. The temperatures at different stages of the oven 33 are adjusted depending on the thickness of the intermediate layer 22 in order to prevent formation of air bubbles and the problem of residual solvent.

The surface-modifying layer 23 requires small thickness and uniform coating due to the high cost incurred in forming the surface-modifying layer 23 and due to a demand of outer appearance. Generally, the rate of drying is maintained at 15 g/m²-20 g/m². If the surface-modifying layer 23 is to be exposed at the outside of a final product, the amount of the coating should be increased. On the other hand, the composition of the surface-modifying layer 23 may or may not be added with a coloring agent. The speed of feeding the fabric 71 must matched the temperatures and the lengths of the ovens 43, 33, 56 and the boiling point of the solvent in order to determine and calculate the drying time and to provide the most suitable parameters for the process. The backing laminate 20 of the composite fabric 1 produced according to the present invention may have a thickness of about 0.03 m-0.13 mm, or a thickness according to the quality demanded by the product.

As described hereinbefore, the backing laminate 20 is a three-layered laminate. However, the present invention is not laminated thereto. In case a backing laminate with high scratch resistance is desired, instead of applying the surface-modifying layer 23, a polyurethane coating may be provided on the intermediate layer 22 with an additional binder layer 21 disposed between the intermediate layer 22 and the polyurethane coating.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A composite fabric comprising:
a fabric layer and a backing laminate,
said backing laminate including a binder layer applied to said fabric layer, an intermediate layer applied to said binder layer, and a surface-modifying layer applied to said intermediate layer,
said binder layer having a binder composition which contains a styrene-butadiene-styrene block copolymer grafted with an acrylate monomer, and polyurethane blended with said styrene-butadiene-styrene block copolymer which has been grafted,
said intermediate layer having a composition which contains a styrene-butadiene-styrene block copolymer and a solvent.

2. The composite fabric as claimed in claim 1, wherein said surface-modifying layer includes a styrene-butadiene-styrene block copolymer grafted with an acrylate monomer, polyurethane blended with said styrene-butadiene-styrene block copolymer which has been grafted, a lubricant and a matting agent.

3. The composite fabric as claimed in claim 1, wherein the viscosity of the styrene-butadiene-styrene block copolymer which has been grafted with the acrylate monomer is 15,000 cps-30,000 cps.

4. The composite fabric as claimed in claim 1, wherein the viscosity of the composition of the intermediate layer is about 18,000 cps-20,000 cps.

5. The composite fabric as claimed in claim 1, wherein the composition of the intermediate layer further includes a plasticizer.

6. The composite fabric as claimed in claim 1, wherein the solvent of the composition of the intermediate layer is selected from a group consisting of toluene, n-butyl acetate and cyclohexane.

7. The composite fabric as claimed in claim 5, wherein the plasticizer is selected from a group consisting of a paraffinic oil and a naphthenic oil.

8. The composite fabric as claimed in claim 1, wherein the surface-modifying layer is a polyurethane coating.

9. A method for fabricating a composite fabric comprising: providing a fabric layer with a binder layer which is prepared by grafting a styrene-butadiene-styrene block copolymer with an acrylate monomer and by blending polyurethane with said styrene-butadiene-styrene block copolymer which has been grafted;
applying an intermediate layer to said binder layer, said intermediate layer being formed from a composition which contains a styrene-butadiene-styrene block copolymer and a solvent; and
applying a surface-modifying layer to said intermediate layer.

10. The method as claimed in claim 9, wherein said surface-modifying layer is formed from a composition which is prepared by grafting a styrene-butadiene-styrene block copolymer with an acrylate monomer and by mixing the grafted styrene-butadiene-styrene block copolymer with polyurethane, a lubricant and a matting agent.

11. The method as claimed in claim 9, wherein said binder layer is applied through a suspension coating process.

12. The method as claimed in claim 11, wherein said intermediate layer is applied through a gap coating process.

13. The method as claimed in claim 12, wherein said surface-modifying layer is applied through a gravure coating process.

14. The method as claimed in claim 9, wherein the viscosity of the styrene-butadiene-styrene block copolymer which has been grafted with the acrylate monomer is 15,000 cps-30,000 cps.

15. The method as claimed in claim 9, wherein the viscosity of the composition of the intermediate layer is about 18,000 cps-20,000 cps.

16. The method as claimed in claim 9, wherein the backing laminate has a thickness of about 0.03 mm-0.15 mm.
